(19) United States
(12) Patent Application Publication
(10) Pub. No.: US 2008/0110352 A1
(43) Pub. Date: May 15, 2008

(54) ENCLOSABLE CRISPER BAKER ASSEMBLY HAVING AN ADJUSTABLE BAKING VOLUME

(75) Inventors: William J. Lazaroff, Floral Park, NY (US); Adam Krent, Brooklyn, NY (US)

Correspondence Address: TROUTMAN SANDERS LLP, 600 PEACHTREE STREET , NE, ATLANTA, GA, 30308, US

(73) Assignee: Lifetime Brands, Inc., Garden City, NY (US)

(21) Appl. No.: 11/939,459

(22) Filed: Nov. 13, 2007

Related U.S. Application Data
(60) Provisional application No. 60/865,788, filed on Nov. 14, 2006.

(51) Int. Cl. A23P 1/00

(52) U.S. Cl. 99/426

(57) ABSTRACT

An enclosable crisper baker assembly for baking food items. The enclosable crisper baking assembly includes an upper baking sheet and a lower baking sheet each having a baking well adapted for receiving food items. The lower baking sheet includes a locking and attachment mechanism for temporarily locking and maintaining a connection between the upper baking sheet and the lower baking sheet. When the upper baking sheet is attached to the lower baking sheet a cavity is defined between the two baking sheets, such that the cavity is adapted to adequately maintain food items to be baked and browned properly.

### BACKGROUND OF THE INVENTION

1. Field of the Invention

The present invention relates generally to a crisper baker assembly for cooking, and in particular to an enclosable crisper baker assembly having an adjustable size.

2. Description of Related Art

Baking pans and cookie sheets are commonly used throughout the baking industry for the containment of baked goods during the preparation process. Baking pans are offered in a variety of shapes and sizes, and can also provide baking molds or wells to assist in properly shaping baked foods. Baked goods generally include a variety of food dishes prepared as entries, side dishes, and/or desserts.

As most ovens used for baking include a heating element below the oven racks, foods placed in baking pans are typically cooked from the bottom. Accordingly, cooks are often required to rotate or flip over food products during the baking process to ensure even cooking. If not properly rotated, one side of the food product may be more done (or even burnt) than the opposite side of the food product.

Many utensils such as tongs and spatulas are used to rotate the food products within the baking pan during the baking process. Unfortunately, the process of pulling out the baking pan, using a utensil to flip over each of the baking products, and putting the baking pan back into the oven can be a difficult, time consuming process, and detrimentally allow heat to escape the oven. Often, the oven door is left open and one of the oven racks is pulled out in order to provide the cook access to the food products for rotation. Such a procedure can lead to heat loss in the oven, thereby increasing the time necessary to adequately cook the food products.

Some food products, such as french fries and tater tots, present unique difficulties in flipping over for balanced cooking because of the sheer volume of the food items to rotate. To save time, many cooks will gently shake the pan in order to rotate the food items, which results in only some of the food items being properly rotated. Further, shaking of the pan can lead to food items falling out of the baking pan and can increase a cook's exposure to the extremely hot portions of the baking pan, which could lead to injury.

What is needed, therefore, is an enclosable baking assembly that allows for easy flipping or rotation of food products without the use of special utensils. Further, what is needed is an enclosable baking assembly having a cavity used to receive and house food items, such that the cavity can be adjusted in size to accommodate food items of varying sizes. It is to such a device that the present invention is primarily directed.

### BRIEF SUMMARY OF THE INVENTION

Briefly described, in preferred form, the present invention is an enclosable crisper baker assembly for baking food items. The present adjustable baking device can include a first baking sheet having a first baking well, a second baking sheet having a second baking well, and a releasably securable assembly to releasably secure the first baking sheet to the second baking sheet in one of either a first position or a second position.

In the first position, the first baking sheet is releasably secured to the second baking sheet, and the volume enclosed between the first and second baking sheets is a first volume. In the first position, the well of the first baking extends downwards, and the second baking well extends downwards, forming the first volume therebetween. For example, in the first position, the well of the first baking well sits partially within the second baking well.

In the second position, the first baking sheet is releasably secured to the second baking sheet, and the volume enclosed between the first and second baking sheets is a second volume, being large than the first volume. In the second position, the well of the first baking extends upwards, and the second baking well extends downwards, forming the second volume therebetween.

The first baking sheet can be an upper baking sheet, and the second baking sheet can be a lower baking sheet. It will be understood by those of skill in the art that the entire device can be described as having a first and second position (providing the adjustable volume between the sheets), or an individual sheet (for example, the upper sheet) can be described as having a first and second position (providing the adjustable volume between the sheets).

Similarly, the releasably securable assembly can be a locking and attachment mechanism that extends from the lower sheet to lockingly engage the upper sheet, or can be a locking and attachment mechanism that extends from the upper sheet to lockingly engage the lower sheet. For example, the releasably securable assembly can comprise the interplay between one or more attachment clips of the top surface of one of the first and second baking sheets, and one or more apertures of the other of the first and second baking sheets, the one or more apertures being adequately sized to receive the one or more attachment clips.

Thus, in another preferred embodiment, the enclosable crisper baking assembly of the present invention includes an upper baking sheet and a lower baking sheet each having a baking well adapted for receiving food items. The volumes of the baking wells can be the same, or different. For example, the lower baking well can be deeper than the upper baking well.

The lower baking sheet includes a locking and attachment mechanism for temporarily locking and maintaining a connection between the upper baking sheet and the lower baking sheet. When the upper baking sheet is attached to the lower baking sheet, a cavity (baking volume) is defined therebetween, such that the cavity is adapted to adequately maintain food items to be baked and browned properly.

The upper baking sheet includes a first position and a second position for engagement with the lower baking sheet. In the first position, the baking well of the upper baking sheet is received by the baking well of the lower baking sheet, thereby creating a cavity having a first size and volume. In the second position, the upper baking sheet is flipped over, so that the baking well of the upper baking sheet is positioned opposite the baking well of the lower baking sheet. Accordingly, a cavity is defined having a second size and volume that is greater than the first size and volume of the first position. The user, therefore, can adjust the size of the cavity to facilitate differently sized food items.

During use, food items are received by the baking well of the lower baking sheet. The upper baking sheet is then attached via the locking and attachment mechanism to the lower baking sheet. The enclosed crisper baker assembly is then placed on an oven rack within an oven for baking. At the appropriate time, the user can flip the entire enclosable crisper baker assembly to ensure thorough and even cooking of the food items. The user, therefore, does not have to use special utensils, such as tongs or spatulas, to rotate or flip each of the food items during the baking process.

The locking and attachment mechanism can include the interplay between attachment clips connected to the lower baking sheet and a plurality of apertures of the upper baking sheet designed to adequately receive the attachment clips. The attachment clips can include a clip cover and button made of, or coated with, a gripping material that assists in maintaining the enclosable crisper and baker in a temporarily locked position. Generally, the user places the upper baking sheet on top of the lower baking sheet, so that the attachment clips of the lower baking sheet are received by the apertures of the upper baking sheet. The user can then apply a slideable force to the upper baking sheet, thereby causing the attachment clips to grasp onto the top of the upper baking sheet. After use, the user can then apply a second, opposite slideable force to the top of the upper baking sheet to disengage the attachment clips from the upper baking sheet. The user can then lift the upper baking sheet off of the lower baking sheet to access the baked food items.

These and other objects, features and advantages of the present invention will become more apparent upon reading the following specification in conjunction with the accompanying drawings.

### BRIEF DESCRIPTION OF THE FIGURES

FIGS. 1A-1E, collectively known as FIG. 1, illustrate orthographic and sectional views of a lower baking sheet of an enclosable baking pan assembly in accordance with preferred embodiments of the present invention.

FIG. 2 illustrates a detail view of a handle attachment mechanism of the lower baking sheet in accordance with an alternative embodiment of the present invention.

FIG. 3 illustrates a detail view of an attachment clip of the lower baking sheet for receiving an upper baking sheet of the enclosable baking pan assembly in accordance with preferred embodiments of the present invention.

FIGS. 4A-4E, collectively known as FIG. 4, illustrate orthographic and sectional views of an upper baking sheet of the enclosable baking pan assembly in accordance with an alternative embodiment of the present invention.

FIGS. 5A-5C, collectively known as FIG. 5, illustrate the enclosable baking pan assembly in an adjusted first position in accordance with preferred embodiments of the present invention.

FIGS. 6A-6C, collectively known as FIG. 6, illustrate the enclosable baking pan assembly in an adjusted second position in accordance with preferred embodiments of the present invention.

### DETAILED DESCRIPTION OF PREFERRED EMBODIMENTS

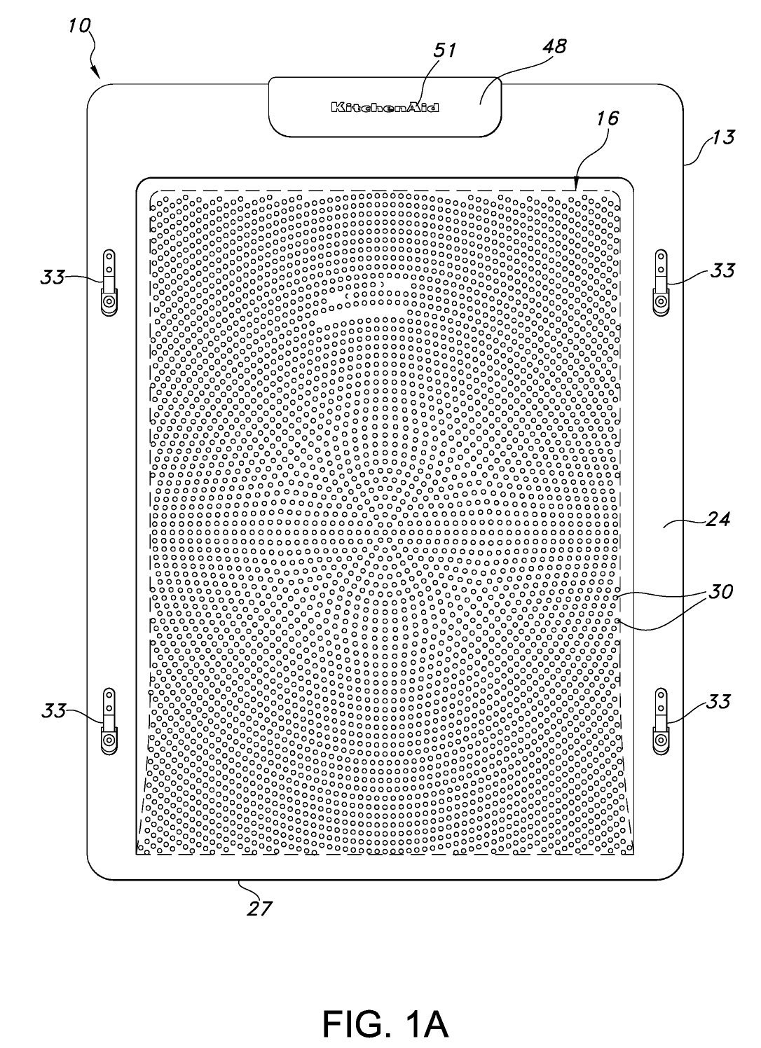

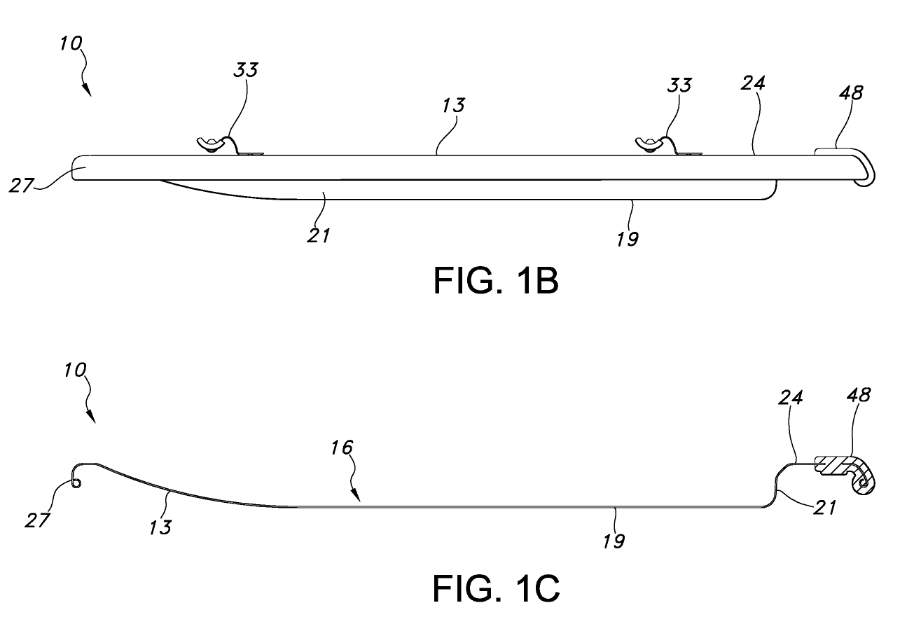

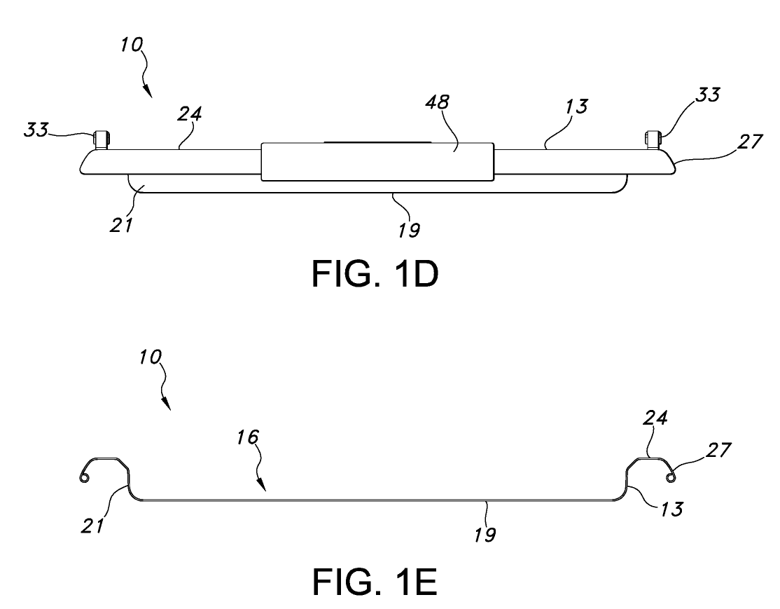

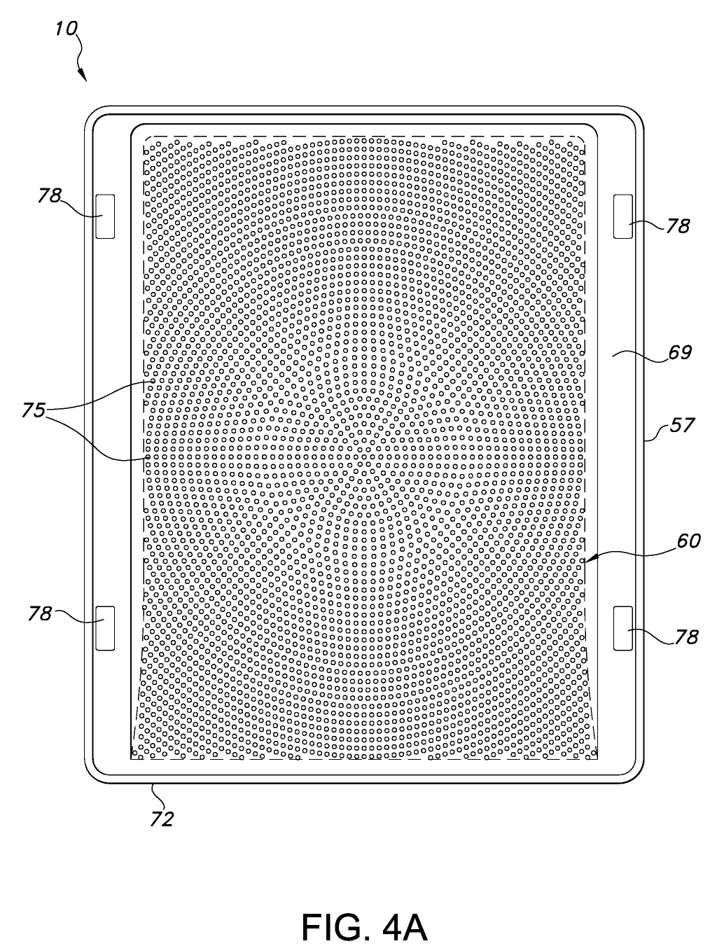

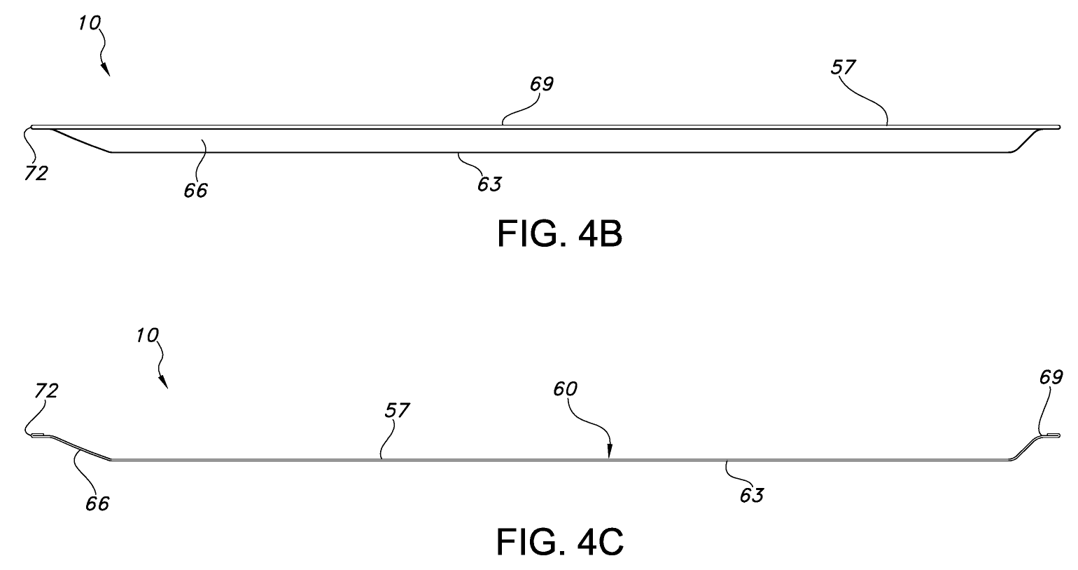

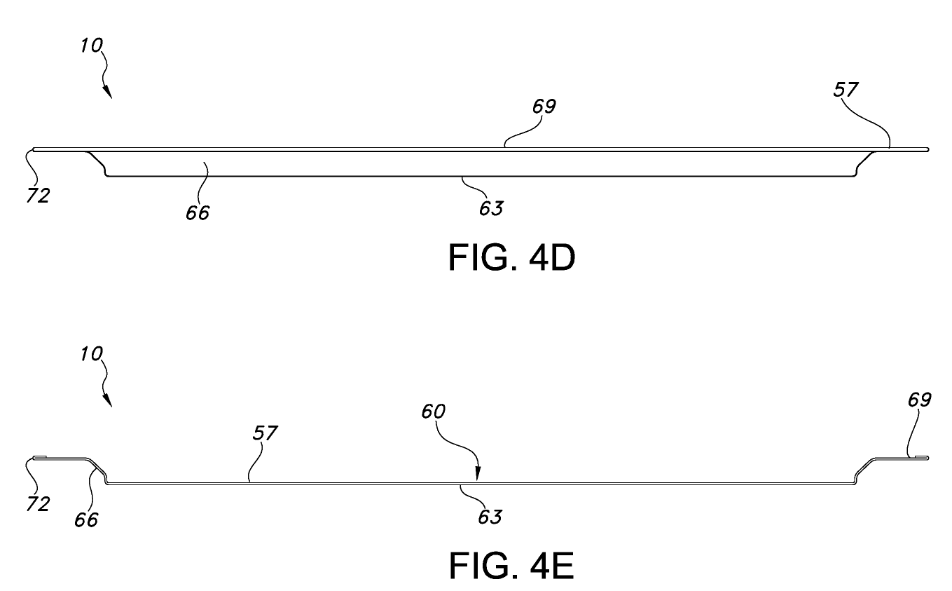

Referring now in detail to the drawing figures, wherein like reference numerals represent like parts throughout the several views, the present invention of FIGS. 1 and 4 provides an enclosable crisper baker assembly 10, which permits a user to rotate or flip over food items during the baking process without the use of special utensils, such as tongs or spatulas. The enclosable crisper baker assembly 10 is designed for receiving baking contents within an adjustable cavity (also referred to herein as a baking well) to accommodate baking contents of various shapes and sizes.

Generally, the present enclosable crisper baker assembly 10 includes a lower baking sheet 13 and an upper baking sheet 57 that can be temporarily locked together to form a cavity or combined baking well therebetween. During use, the enclosable crisper baker assembly 10 can receive food items within the defined cavity. For example, the food items can be placed on the lower baking sheet 13 and, then, the upper baking sheet 57 can be placed over the food items. The upper baking sheet 57 engages and temporarily locks with the lower baking sheet 13. The user can then put the enclosable crisper baker assembly 10, with the lower baking sheet 13 facing downward, onto an oven rack within the oven.

When the user needs to flip or rotate the baking food items, the user merely flips over the enclosable crisper baker assembly 10, thereby positioning the opposite, less-cooked side of the food items on the upper baking sheet 57, which is now closer to the heating element of the oven (should the over have only a bottom heating element). Accordingly, both sides of the food items can receive proper and thorough heating during the baking process. Once the baking process has completed, the user can easily disengage the upper baking sheet 57 from the lower baking sheet 13 to access the baked food items within the enclosable crisper baker assembly 10.

The present invention, therefore, reduces the overall baking time. The baking time is reduced because there is no need to flip each item during the cooking process, which could release heat from the oven. Further, the upper baking sheet 57 and lower baking sheet 13 allow food products to cook or brown on both sides simultaneously. As the oven door need not be open as long to flip the enclosable crisper baker assembly 10, energy is saved in the process. Accordingly, the overall cost of food preparation is reduced.

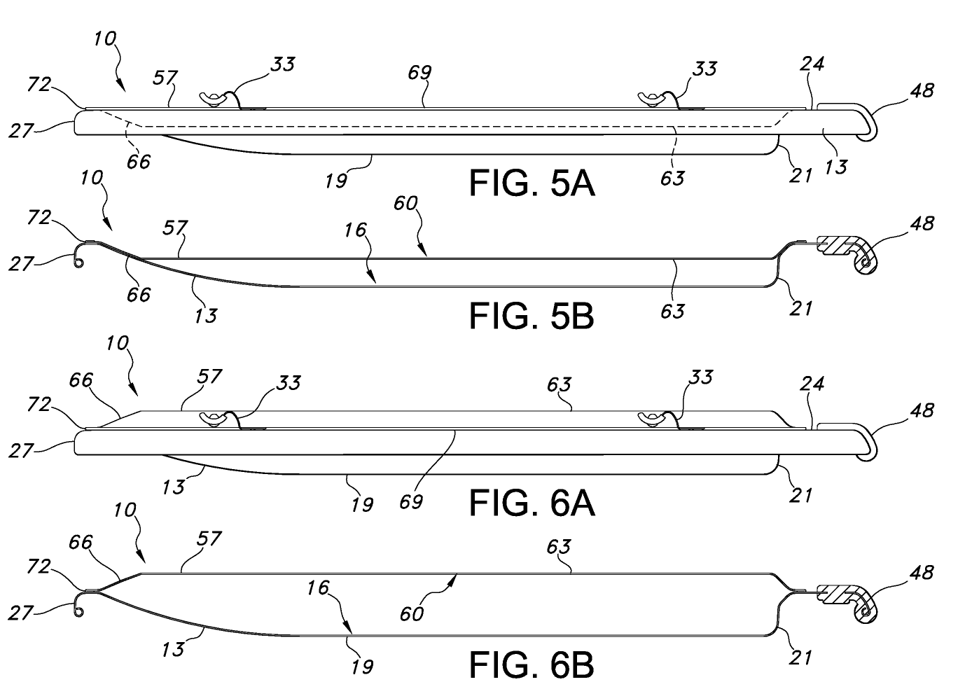

The upper baking sheet 57 is adapted to temporarily lock with the lower baking sheet 13 in a first and a second position. In the first position (FIG. 5), the upper baking sheet 57 is placed onto the lower baking sheet 13, such that the baking well 60 within the upper baking sheet 57 is received within the baking well 16 of the lower baking sheet 13. In the first position, therefore, the cavity defined between the upper baking sheet 57 and the lower baking sheet 13 is of a first size or volume.

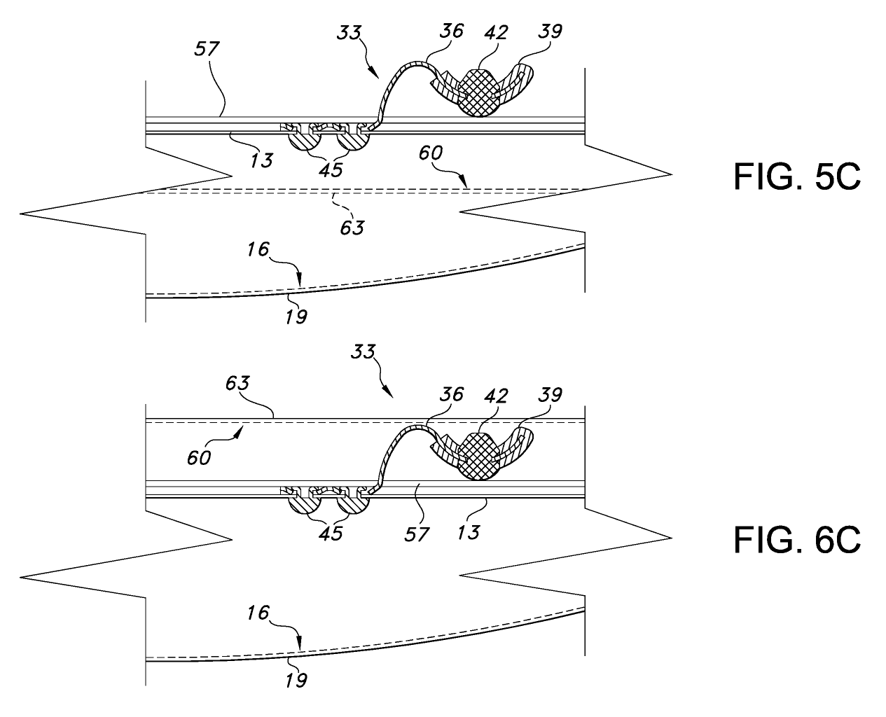

In the second position (FIG. 6), the upper baking sheet 57 is flipped upside down, such that the baking well 60 within the upper baking sheet 57 is positioned opposite the baking well 16 of the lower baking sheet 13. In the second position, therefore, the cavity defined between the upper baking sheet 57 and the lower baking sheet 13 is of a second size or volume that is larger than the first size or volume of the first position. Accordingly, the enclosable crisper baker assembly 10 provides an adjustable cavity (defined by the baking well 60 of the upper baking sheet 57 and the baking well 16 of the lower baking sheet 13) to adequately receive food items of various shapes and sizes.

More specifically, the enclosable crisper baker assembly 10 comprises a lower baking pan 13, an upper baking pan 57, and a temporary locking and attachment mechanism 33 to connect the lower baking pan 13 with the upper baking pan 57. As described more fully below, the temporary locking and attachment mechanism 33 can connect the lower baking pan 13 and the upper baking pan 57 in the first position and the second position, such that the first position defines a cavity having a first size or volume between the lower baking pan 13 and the upper baking pan 57, and the second position defines a cavity having a second (larger) size or volume between the lower baking pan 13 and the upper baking pan 57.

FIGS. 1A-1E illustrate various orthographic and sectional views of the lower baking sheet 13 of the present invention. The lower baking sheet 13 generally defines a baking well 16 that extends downwardly from a top 24 of the lower baking sheet 13 to form a partial cavity for receiving food items. The baking well 16 can include a bottom surface 19 and lateral sidewalls 21 that extend from the bottom surface 19 to the top 24 of the lower baking sheet 13. The baking well 16, therefore, is adapted to receive and maintain food items within the lower baking sheet 13 during the baking process.

The top 24 of the lower baking sheet 13 can include a periphery that extends or rolls downwardly to form a lip 27, thereby allowing a user to more effectively grasp and move the lower baking sheet 13 during use. The lip 27 of the top 24 can also provide structural strength to the lower baking sheet 13 to limit deformation or warping during use of the enclosable crisper baker assembly 10. The lip 27 provides a rounded edge that reduces the number of sharp edges present on the lower baking sheet 13. Furthermore, the top 24 of the lower baking sheet 13 can also include protrusions, ridges, or other structures (not shown) to effectively increase its rigidity and minimize undesired flexing.

Optionally, the bottom surface 19 of the baking well 13 can define a plurality of apertures 30 to assist in the cooking of the food items. Typically, the plurality of apertures 30 are small enough to ensure that portions of the food items do not fall out of or through the lower baking sheet 13, but are large enough to allow heated air to rise up from a heating element and through the bottom surface 19 of the baking well 16. The perforated bottom surface 19 assists, therefore, in providing a more even and thorough baking of the food items.

The lower baking sheet 13 can further comprise the temporary locking and attachment mechanism 33. The temporary locking and attachment mechanism 33 is adapted to engage the lower baking sheet 13 with the upper baking sheet 57, thereby forming a cavity for receiving food items. The temporary locking and attachment mechanism 33 further prevents the lower baking sheet 13 and the upper baking sheet 57 from accidentally disengaging from each other during use. The temporary locking and attachment mechanism 33, therefore, maintains the connection between the lower baking sheet 13 and the upper baking sheet 57 until the user disengages the temporary locking and attachment mechanism 33.

Generally, the temporary locking and attachment mechanism 33 is positioned on the top 24 of the lower baking sheet 13, such that the temporary locking and attachment mechanism 33 is located between the baking well 16 and the lip 27 of the lower baking sheet 13. One skilled in the art will recognize that the temporary locking and attachment mechanism 33 can include, but is not limited to, a bolt, dowel, pin, peg, post, hinge, channel, track, clamp, clip, fastener, rivet, screw, tongue and groove, hook, key, latch, lock, mate, nut, nail, or other attachment structure.

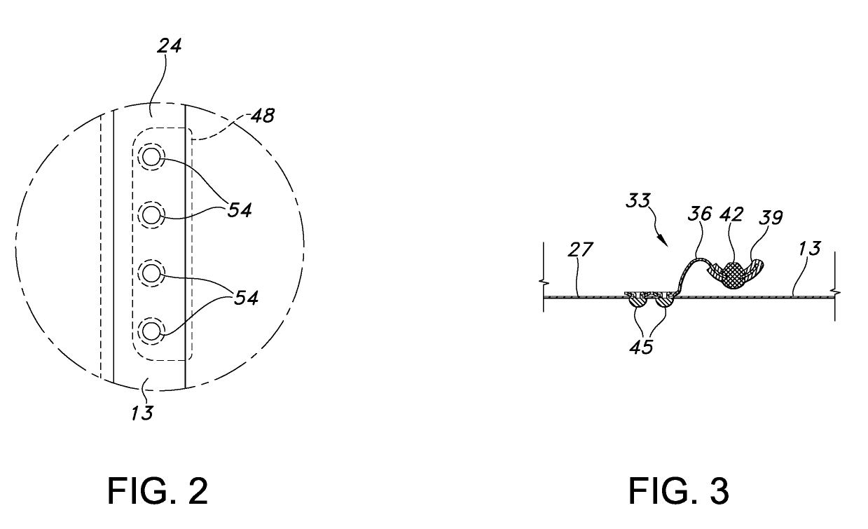

In an alternative embodiment of the present invention, the lower baking sheet 13, as illustrated in FIGS. 1 and 2, includes a handle 48 adapted to allow for easy handling of the enclosable crisper baker assembly 10 by the user. The handle 48 is generally positioned at one end of the lower baking well 16. To accommodate the handle 48, the lower baking sheet 13 can include a plurality of apertures 54 adapted to receive the handle 48 and maintain the connection between the handle 48 and the lower baking well 16. Accordingly, the handle 48 can include extensions (not shown) that extend downwardly from the top of the handle 48 and can be inserted into the plurality of apertures 54 of the top 24 of the lower baking sheet 13. Further, the handle 48 can wrap around the lip 27 of the lower baking sheet 13, so that a bottom of the handle 48 can engage with the downward extensions from the top of the handle 48.

Additionally, the handle 48 can include indicia 51 generally positioned on the top surface of the handle 48, so that the indicia 51 is easily viewed when the lower baking sheet 13 is placed on the counter or on the oven rack. One skilled in the art will recognize that the indicia 51 can include a variety of appropriate instructions or notices for the individual. For example, and not limitation, the indicia 51 can include a brand name, various measuring units of volume (such as the volume defined by the baking well 16), or instructions on how to use the enclosable crisper baker assembly 10.

In another embodiment of the present invention, the locking and attachment mechanism 33 positioned on the top 24 of the lower baking well 13 can be in the form of a plurality of attachment clips 33. The plurality of attachment clips 33 can be located at predetermined locations along the top 24 of the lower baking well 13 to ensure adequate attachment of the lower baking sheet 13 with the upper baking sheet 57. The plurality of attachment clips 33 can also allow for the lower baking well 13 to be temporarily locked with the upper baking well 57 during use.

Each attachment clip 33 can include a bias element 36 (such as a spring) having a first end and a second end. The first end of the bias element 36 is attached to the top 24 of the lower baking sheet 13. Generally, the first end of the bias element 36 is permanently attached to the lower baking sheet 13 by the use of at least one rivet 45. The at least one rivet 45 fastens the first end of the bias element 36 in a fixed position on the top 24 of the lower baking sheet 13.

The second end of the bias element 36 can include a clip cover 39 and a button 42. The clip cover 39 and button 42 are generally made of a gripping material that, when engaged, assists in maintaining the lower baking well 13 in a locked position with the upper baking well 57. Moreover, the bias element 36 is generally defined so that the clip cover 39 and button 42 of the second end is biased toward the top 24 of the lower baking sheet 13. Accordingly, material positioned between the top 24 of the lower baking sheet 13 and the attachment clips 33 is held in place by the downwardly applied force of the clip cover 29 and button 42 of the bias element 36. During use, a portion of the upper baking sheet 57 is positioned between the top 24 of the lower baking sheet 13 and the attachment clips 33. As described more fully below with reference to FIGS. 5C and 6C, the attachment clips 33 can properly maintain the connection between the lower baking sheet 13 and the upper baking sheet 57 during use.

One skilled in the art will recognize that the bias element 36 can include, but is not limited to, a spring, a coil, a pressurized chamber, a flexible piece of metal, rubber, or plastic, or other appropriate device that is compressible, yet resilient.

FIGS. 4A-4E illustrate various orthographic and sectional views of the upper baking sheet 57 in accordance with the preferred embodiment of the present invention. The upper baking sheet 57 generally defines a baking well 60 that extends downwardly from a top 69 of the upper baking sheet 57 to form a partial cavity for receiving food items. The baking well 60 can include a bottom surface 63 and lateral sidewalls 66 that extend from the bottom surface 63 to the top 69 of the upper baking sheet 57. The baking well 60, therefore, is adapted to receive and maintain food items within the upper baking sheet 57 during the baking process.

Generally, the baking well 60 of the upper baking sheet 57 is of a smaller size or volume than the baking well 16 of the lower baking sheet 13. When the upper baking sheet 57 is stacked on top of the lower baking sheet 13 (e.g., when the baking well 60 of the upper baking sheet 57 is received by the baking well 16 of the lower baking sheet 13), a cavity is formed between the upper baking sheet 57 and the lower baking sheet 13.

The top 69 of the upper baking sheet 57 can include a periphery that extends or folds backwards upon itself to form a lip 72. The lip 72 provides a rounded edge that reduces the number of sharp edges present on the upper baking sheet 57. Furthermore, the top 69 of the upper baking sheet 57 can also include protrusions, ridges, or other structures (not shown) to effectively increase its rigidity and minimize undesired flexing. The lip 72 of the top 69 can, therefore, provide structural strength to the upper baking sheet 57 to prevent any deformation or warping during use of the enclosable crisper baker assembly 10.

Further, the lip 72 of the upper baking sheet 57 can be further adapted to engage an upper portion of the baking well 16 of the lower baking sheet 13 when in the second position. The engagement between the lip 72 of the upper baking sheet 57 and the upper portion of the baking well 16 of the lower baking sheet 13 assist in maintaining the connection between the upper baking sheet 57 and the lower baking sheet 13 during use.

Optionally, the bottom surface 63 of the baking well 60 can define a plurality of apertures 75 to assist in the cooking of the food items. Typically, the plurality of apertures 75 are small enough to ensure that portions of the food items do not fall out of or through the upper baking sheet 57, but are large enough to allow heated air to rise up from the heating element and through the bottom surface 63 of the baking well 60. The perforated bottom surface 63 assists, therefore, in providing a more even and thorough baking of the food items.

The upper baking sheet 57 can further comprise a plurality of apertures 78 for receiving the temporary locking and attachment mechanism 33. The temporary locking and attachment mechanism 33 of the lower baking sheet 13 engages the plurality of apertures 78 of the upper baking sheet 57, thereby forming a cavity for receiving food items. The interoperation of the temporary locking and attachment mechanism 33 and the plurality of apertures 78 maintains the connection between the lower baking sheet 13 and the upper baking sheet 57 until the user disengages the temporary locking and attachment mechanism 33.

Generally, the apertures 78 for receiving the temporary locking and attachment mechanism 33 temporary locking and attachment mechanism 33 are positioned on the top 69 of the upper baking sheet 57, such that the apertures 78 are located between the baking well 60 and the lip 72 of the upper baking sheet 57. Although described as apertures 78 for receiving the temporary locking and attachment mechanism 33, one skilled in the art will recognize that the upper baking sheet 57 can include, for example, a portion of the temporary locking and attachment mechanism 33, such that a first portion of the temporary locking and attachment mechanism 33 of the lower baking sheet 33 engages a second portion of the temporary locking and attachment mechanism 33 of the upper baking sheet 57. For exemplary purpose only, the lower baking well 13 can include a tongue or prong, while the upper baking sheet 57 can include a corresponding groove or jack receptacle.

In a preferred embodiment of the present invention, the locking and attachment mechanism 33 is an attachment clip 33 positioned on the lower baking well 13 that is slideably received by a corresponding aperture 78 on the upper baking well 57. When slideably engaged, the attachment clip 33 prevents accidental disconnection of the upper baking sheet 57 from the lower baking sheet 13.

During use of the enclosable crisper baker assembly 10, food items are placed within the baking well 16 of the lower baking sheet 13. Prior to inserting into the oven, the upper baking sheet 57 is placed on top of the lower baking sheet 13. Depending on the size of the food items, the upper baking sheet 57 can be placed in the first position (where the baking well 60 of the upper baking sheet 57 is received within the baking well 16 of the lower baking sheet 13) or in the second position (where the upper baking sheet 57 is flipped over, thereby positioning the baking well 60 of the upper baking sheet 57 opposite the baking well 16 of the lower baking sheet 13).

In the first position, as illustrated in FIGS. 5A-5C, the cavity created between the bottom 63 of the upper baking sheet 57 and the bottom 19 of the lower baking sheet 13 is of a first size and volume. Generally used for smaller food items, the first position is obtained by placing the baking well 60 of the upper baking sheet 57 into the baking well 16 of the lower baking sheet 13. Because the baking well 60 of the upper baking sheet 57 is typically smaller than the baking well 16 of the lower baking sheet 13, the food items can be securely maintained within the defined cavity between the upper baking sheet 57 and the lower baking sheet 13 without crushing or deforming the food items.

As the upper baking sheet 57 is received by the lower baking sheet 13, the top 24 of the lower baking sheet 13 can approach the underside of the top 69 of the upper baking sheet 57. The attachment clips 33 positioned on the top 24 of the lower baking sheet 13, therefore, can be adequately received by the plurality of apertures 78 of the upper baking sheet 57. The user can then provide a sliding force upon the upper baking sheet 57, so that the attachment clips 33 (e.g., the clip cover 39 and button 42) can engage the top 69 surface of the upper baking sheet 57. The attachment clips 33 can then maintain the temporarily lock between the lower baking sheet 13 and the upper baking sheet 57 during use.

The user then places the enclosable crisper baker assembly 10 onto an oven rack of the oven to begin baking the food items retained inside the cavity. At the appropriate time, the user simply turns over the enclosable crisper baker assembly 10 to allow for more direct baking of the opposite side of the food items. There is no need to turn over every food item with a utensil, such as tongs or spatulas. Once the baking process has completed, the user can remove the enclosable crisper baker assembly 10 from the oven and disengage the upper baking sheet 57 from the lower baking sheet 13 by directing an opposite sliding force to the upper baking sheet 57. Accordingly, the attachment clips 33 are realigned with the apertures 78 of the upper baking sheet 57, thereby allowing the upper baking sheet 57 to be easily removed from the lower baking sheet 13.

In the second position, as illustrated in FIGS. 6A-6C, the cavity created between the bottom 63 of the upper baking sheet 57 and the bottom 19 of the lower baking sheet 13 is of a second size and volume. The second size and volume of the second position is generally larger than the first size and volume of the first position. Consequently, the second position can be used for larger food items. The second position is obtained by placing the upper baking sheet 57 on top of the lower baking sheet 13, such that the baking well 60 of the upper baking sheet 57 is opposite (e.g., facing upwards) the baking well 16 of the lower baking sheet 13. The larger food items can be securely maintained within the defined cavity between the upper baking sheet 57 and the lower baking sheet 13 without crushing or deforming the food items.

As the upper baking sheet 57 is received by the lower baking sheet 13, the top 24 of the lower baking sheet 13 can approach the top 69 of the upper baking sheet 57. The attachment clips 33 positioned on the top 24 of the lower baking sheet 13, therefore, can be adequately received by the plurality of apertures 78 of the upper baking sheet 57. The user can then provide a sliding force upon the upper baking sheet 57, so that the attachment clips 33 (e.g., the clip cover 39 and button 42) can engage the underside of the top 69 surface of the upper baking sheet 57. The attachment clips 33 can then maintain the temporarily lock between the lower baking sheet 13 and the upper baking sheet 57 during use. The user can then bake the food items in the same manner as described above with reference to FIGS. 5A-5C.

As the present invention includes an upper baking sheet 57 and a lower baking sheet 13, which are separable from each other, one skilled in the art will recognize that the upper baking sheet 57 and lower baking sheet 13 can be used independently/separately as traditional pans or cookie sheets.

The baking wells 16, 60 of the lower baking sheet 13 and upper baking sheet 57 are generally sized and shaped to hold a predefined amount of food items and to retain the food items once baked. The size of the baking wells 16, 60 can be of suitable size or shape. Further, the shape of the baking wells 16, 60 are not limited to a rectangular shape and, therefore, can be defined as suitable shape for baking. Example shapes of usable baking wells 16, 60 include, but are not limited to, circles, squares, ovals, triangles, stars, and hearts. Moreover, the overall dimensions of the upper baking sheet 57 and the lower baking sheet 13 can be of suitable size. This size may be more or less depending on the desired overall size of the oven or other storage container into which the enclosable crisper baker assembly 10 must fit.

The enclosable crisper baker assembly 10 and components thereof are made from a material that can withstand oven temperatures during baking. Such temperatures generally include a range from about 100° F. to about 450° F. (or about 38° C. to about 232° C.). Higher or lower temperatures may be used depending on the ingredients used in baking. Further, the upper baking sheet 57, lower baking sheet 13, and components thereof can be made of a material that can also withstand cold temperatures when, for example, the present invention is placed in a refrigerator or freezer. Accordingly, the material can also withstand temperatures ranging from about −10° F. to about 60° F. (or about −23° C. to about 15° C.).

The upper baking sheet 57, lower baking sheet 13, and components thereof can be made out of metal, coated metal, plastic, or other suitable materials which can withstand oven temperatures. The enclosable crisper baker assembly 10 is preferably made of metal, in order to both withstand oven temperatures and provide proper support for the baking wells 16, 60. The enclosable crisper baker assembly 10 can be made out of other materials which can withstand oven temperatures, while providing a rigid support for the baking wells 16, 60.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. An adjustable baking device comprising:
a first baking sheet having a first baking well;
a second baking sheet having a second baking well; and
a releasably securable assembly to releasably secure the first baking sheet to the second baking sheet in one of either a first position or a second position;
wherein in the first position, the first baking sheet is releasably secured to the second baking sheet, and the volume enclosed between the first and second baking sheets is a first volume; and
wherein in the second position, the first baking sheet is releasably secured to the second baking sheet, and the volume enclosed between the first and second baking sheets is a second volume, being large than the first volume.

2. The adjustable baking device of claim 1, wherein in the first position, the well of the first baking well sits partially within the second baking well.

3. The adjustable baking device of claim 2, wherein in the first position, the well of the first baking extends downwards, and the second baking well extends downwards, forming the first volume therebetween.

4. The adjustable baking device of claim 1, wherein in the second position, the well of the first baking extends upwards, and the second baking well extends downwards, forming the second volume therebetween.

5. The adjustable baking device of claim 1, wherein the volume of the first baking well is different than the volume of the second baking well.

6. An adjustable baking device comprising:
a first baking sheet having a first baking well with a bottom surface;
a second baking sheet having a second baking well with a bottom surface; and
a releasably securable assembly to releasably secure the first baking sheet to the second baking sheet in one of either a first position or a second position;
wherein in the first position, the first baking sheet is releasably secured to the second baking sheet, and the volume enclosed between the first and second baking sheets is a first volume, and wherein well of the first baking extends downwards, and the second baking well extends downwards, forming the first volume therebetween;
wherein in the second position, the first baking sheet is releasably secured to the second baking sheet, and the volume enclosed between the first and second baking sheets is a second volume, being large than the first volume, and wherein the well of the first baking extends upwards, and the second baking well extends downwards, forming the second volume therebetween; and
wherein the first baking well bottom surface and the second baking well bottom surface incorporate an aperture therethrough.

7. The adjustable baking device of claim 6, the first baking well bottom surface and the second baking well bottom surface incorporating a plurality of apertures therethrough.

8. The adjustable baking device of claim 7, the first baking well extending downwardly from a top surface of the first baking sheet, the second baking well extending downwardly from a top surface of the second baking sheet, and the releasably securable assembly comprising the interplay between one or more attachment clips of the top surface of one of the first and second baking sheets and one or more apertures of the other of the first and second baking sheets, the one or more apertures being adequately sized to receive the one or more attachment clips.
